(19) United States
(12) Patent Application Publication
(10) Pub. No.: US 2014/0152850 A1
(43) Pub. Date: Jun. 5, 2014

(54) CAPTURING IMAGES FROM A VIDEO CARD USING A CHANGE DETECTION ALGORITHM

(71) Applicant: Ivo Martinik, Ostrava-Poruba (CZ)

(72) Inventor: Ivo Martinik, Ostrava-Poruba (CZ)

(21) Appl. No.: 13/706,010

(22) Filed: Dec. 5, 2012

(51) Int. Cl. H04N 5/232

(52) U.S. Cl. CPC H04N 5/23222
USPC 348/207.1

(57) ABSTRACT

A method whereby a presenter may capture images directly from a graphics control circuitry during a presentation without the need for actions, such as mouse clicks, which would interfere with the presenter's ability to present information to an audience. The method automatically captures images using a change detection algorithm and stores those images in digital form for future use. The presenter or user of the method may make adjustments to the parameters, via a control interface, used by the algorithm to determine when to capture and store a static image from the graphics control circuitry.

### BACKGROUND AND SUMMARY OF THE INVENTION

There is little doubt that the effectiveness of instructional materials such as classroom, business and other presentations are improved with illustrations. For best effect and retention of audience interest, illustrations should be consecutive, showing incremental changes in the material displayed and perhaps most importantly, show the image with sufficient clarity for the viewer to be able to discern the information contained in the presentation. Generating these illustrations can be time consuming and difficult, detracting from the ultimate goal, that being to communicate a concept to an audience.

Past methods of capturing screen images have included using print screen functionality often contained in computer operating systems. Such an approach requires the presenter to identify an image displayed on a computer screen while using a series of keystrokes to “copy” an image and “paste” it into a document. There are also programs that allow the user to capture screen images from within a software user interface that may be configured to store the selected images without the copy and paste steps described above. Examples of such solutions are computer programs such as Snagit® (www.techsmith.com) and Captivate® (www.adobe.com/captivate). Despite the elimination of the “cut” and “paste” steps, users of these existing software programs are still required to manually select and initiate the storage of images created using a program such as PowerPoint® or other, similar computer programs. A major shortcoming of this approach is that it requires the user to create the images ahead of time and in a manner that each image shows an incremental step of the information to be conveyed. Further, using these methods require the user to wait for an image to appear, and then pause to select and copy the image for storage. If a presenter were attempting to capture images during a presentation, these actions would require the presenter to wait for a new or significantly changed image to appear and then pause the delivery of the presentation while performing the steps necessary to store that image before resuming.

An experienced presenter will realize that it is important that illustrative images are captured frequently enough that they do not confuse a viewer. In order for a series of images to best portray the concepts presented during a presentation, those images should convey incremental images that represent a series of steps from one concept to the next. Failure to create incremental images results in a series of summary images which, while they may make good key points, do not provide the viewer with the incremental pieces of information needed to bridge the gap from one concept image to the next.

A solution to the problem of the need for high levels of user involvement required with the image capture approaches just described has been the use of a video camera to record an entire presentation. This approach allows for capture of images as they are displayed on a computer monitor or an overhead projector. While this solves the problem of capturing enough images to avoid the problem of large gaps from one summary image to the next, it suffers from the problem of capturing much more information than is needed, capturing hundreds or even thousands of nearly identical images. As a result of the large number of images, the video files obtained from the use of a video camera are extremely large and difficult to easily store and deliver to potential audiences. The highly compressed video images (frames) of video files are also of much lower quality than bitmap images captured directly from a computer system.

Other methods of capturing displayed images employ external video capture devices (video grabbing cards) in conjunction with driver software to capture images from a video source. An example of this type of technology is the Encore ENMVG-2 Audio Video Grabber device. These types of external devices require the operator to capture the entire video recording or to select small segments of a video recording and as a result, still suffer from the large file size and image quality problems present with the use of the video camera method previously described.

The present invention provides an improvement to the process whereby the user of the invention may capture images from a computerized device for later use. The invention allows the user to capture said images automatically and without continuous actions by the user. The present invention allows the user to optimize the capture of said images so as to capture a sufficient number of images to allow a later viewer of the images to understand the material presented without capturing such a large number of images that the resultant image data file becomes difficult to store and transmit to a later viewer.

In computer software embodying the principles of the invention, the problems associated with the user having to remain actively involved in the image capture process, significant gaps in information content from one image to the next, and the problems associated with managing and distributing large files are addressed by providing a method for automatically capturing full resolution static images from a computing device without the need for any additional hardware, detecting changes to the image and automatically storing single static images when the image has changed a reasonable amount. This approach avoids capturing large numbers of identical images as is the case with a video camera but allows for captures that are frequent enough so that the images captured represent a sufficiently detailed summary of the presented material as to allow the viewer to comprehend the material.

In the present implementation of the invention, the amount of generated data is optimized by a suitable algorithm. In an exemplary embodiment of the algorithm a new full resolution static image (a picture slide) may be created when the following are true:
The original picture has changed appreciably (what is a reasonable amount of change may be pre-set by the user); and/or,
Enough time has passed since the previous picture slide was captured (again, what is “enough” time may be pre-set by the user); and/or,
The picture is relatively stable (the source data has not changed very much over a predetermined period of time).

The advantages of this algorithm is that it allows the user to initiate a static image capture process using pre-set parameters and then focus on the presentation being created without having to be concerned with the mechanics of the image capture process. If the presenter or operator of the software embodying the algorithm wishes to increase or decrease the amount of detail captured, he or she may choose to adjust the adjust parameters of the software to determine when an image is captured and stored, through use of a user interface presented on the computer or other device running the image capture software.

Further features of the capture algorithm of the present invention may include controls that allow the operator to adjust the image capture parameters such as a sliding control adjustment that may be adjusted from more detail to less detail settings without the user having to adjust each parameter separately. Additional functions such as a view of the images being captured and indicators which display the number of images captured and total file size of the captured images improve the operator's ability to optimize the image capture process. If the user desires to create a complete presentation, the image capture algorithm may be further combined with an interface to audio or video capture hardware to create a file that combines both an audio or audio/video recording and the images captured by the algorithm whereby the images are keyed to allow for a playback of those images displayed in synchronization to the audio or audio/video recording.

In addition to the novel features and advantages mentioned above, other benefits will be readily apparent from the following descriptions of the drawings and exemplary embodiments.

### BRIEF DESCRIPTION OF THE DRAWINGS

FIG. 1 is a block diagram of a representative illustration of a personal computer implementing the image capture algorithm.

FIG. 2 is a flow diagram of an exemplary embodiment of the logic for performing the main steps of an image capture software program.

FIG. 3 is a flow diagram of an exemplary embodiment of the logic for performing the steps of initializing and displaying user interface screens of an image capture software program.

FIG. 4 is a graphical representation of an exemplary embodiment of a user interface used for an image capture program.

FIG. 5 is a graphical representation of an exemplary embodiment of a user interface used to adjust image capture parameters.

FIGS. 6A-6C are flow diagrams of an exemplary embodiment of the logic for performing the steps of an embodiment of an image capture algorithm.

FIG. 7 is a flow diagram of an exemplary embodiment of the logic for performing the main steps of synchronizing captured images with an audio or audio/video recording in accordance with the present invention.

### DETAILED DESCRIPTION OF EXEMPLARY EMBODIMENT(S)

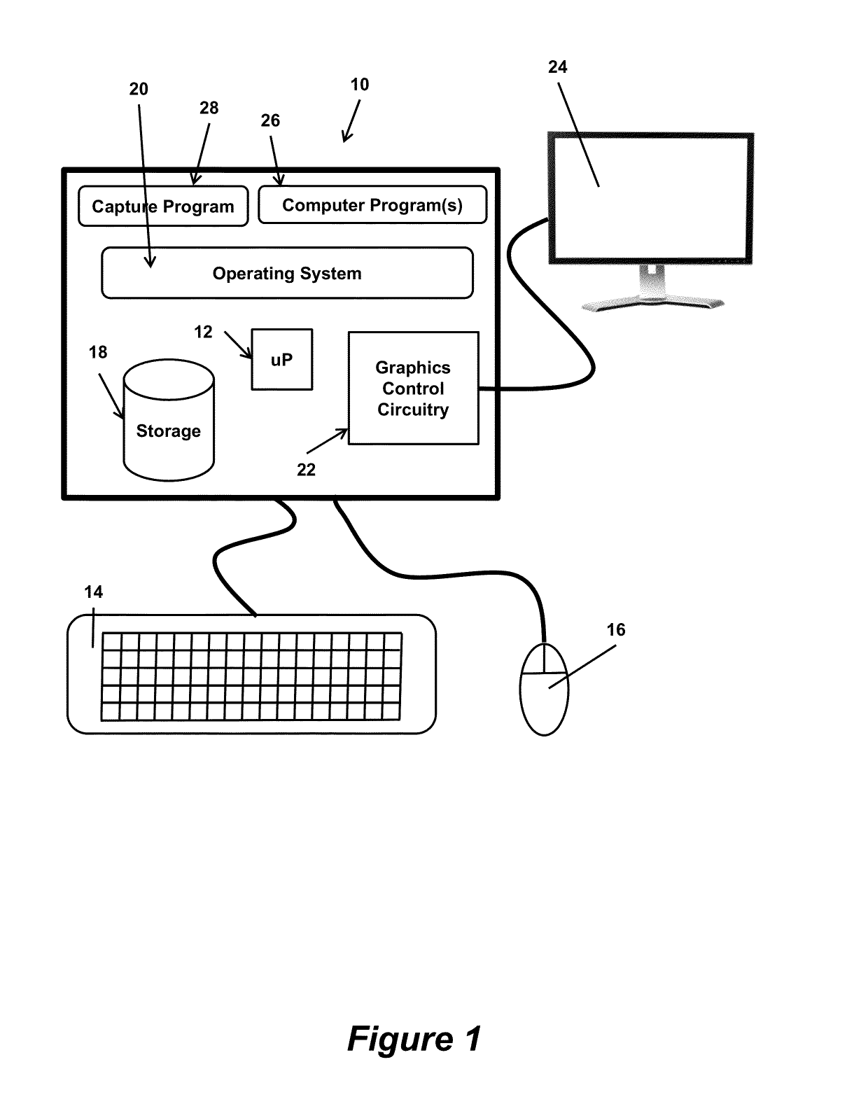

FIG. 1 is a graphic block diagram showing generally a personal computer 10, which depicts a programmatic implementation of the invention. In an embodiment of the present invention, the computer may comprise a processor 12, keyboard 14, a pointing device such as a mouse 16, computer storage (storage drive) 18, a computer operating system 20, graphics control circuitry (the graphics card) 22, and a computer display monitor 24. In a computer system as illustrated, various computer programs 26 in addition to the operating system 20 will generate images which the computer operating system then directs to the graphics control circuitry 22 connected to the computer. The graphics control circuitry further processes the image data and sends it in a manner and format such that the image will appear on a computer display monitor connected to the computer 24.

In one implementation of the image capture algorithm, image capture software 28, which implements the algorithm is installed and caused to run by the user of the computer 10. The software, when instructed to start the capture process by the user, begins to monitor images that the computer operating system 20 has directed to the graphics control circuitry 22.

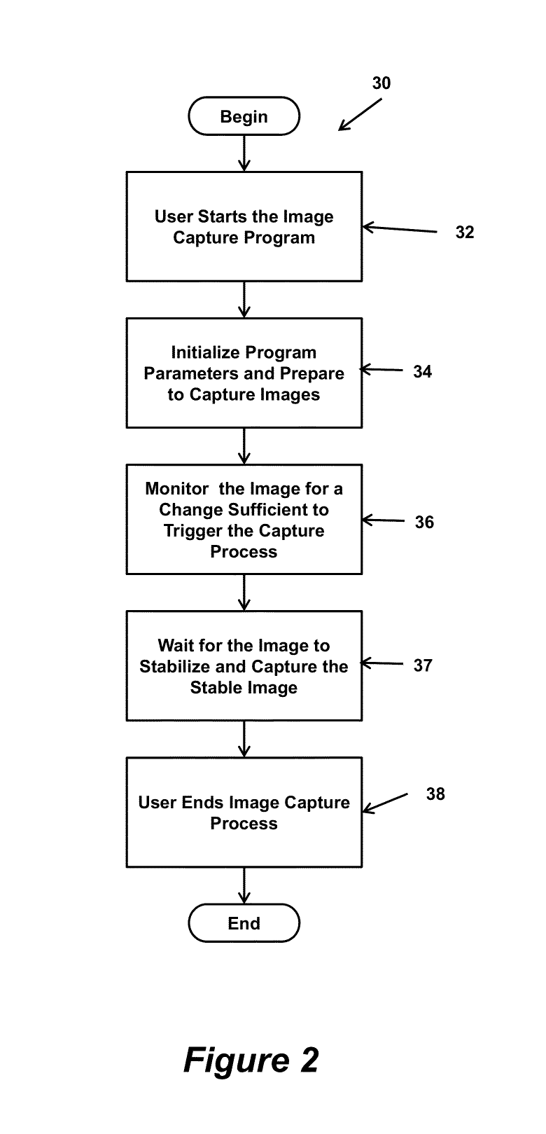

Referring to FIG. 2, a diagram is shown of an exemplary implementation of image capture software 30 containing the image capture algorithm which may be running on a personal computer or other computerized device. It should be noted that an implementation of such software might be performed on any number of computerized devices, a partial list of which may comprise; personal computers, laptop computers, tablet computers, and smartphone type devices and that FIG. 2 is illustrative of only one such implementation.

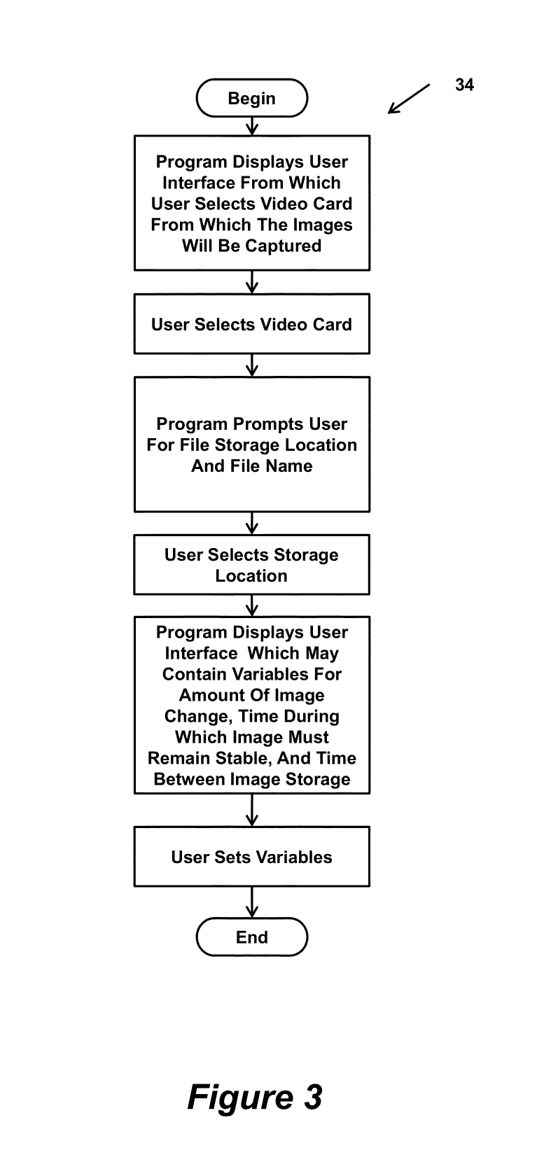

When the user of the computer wishes to capture images using software embodying the current invention, that user will select the software and cause the computer to execute or run the software 32. Referring to FIG. 3, once the software is running, the software may then initialize various parameters used to perform the image capture algorithm 34 and wait for input from the user of the computer to initiate the capture and storage process. In an exemplary embodiment of the invention, the software uses parameters previously stored which may be default values preprogrammed into the software or parameters previously selected by a user. The present invention enables the user to select the values of the parameters, values that the user believes are most helpful to the image capture the user desires to achieve with the present invention. For example, the user may select the storage location for the images captured. The user may select the amount (or percentage) of the image change before capture occurs. The user may select the amount of time the image remains stable before another capture of an image occurs. The user may select an amount of time between images being captured. Once the user makes his/her selections the interface enables the user to set or fix these variables for operation of the program throughout the image capture process. If the user desires to change any of the variables the user may do so by going back to the interface variable options the program offers.

To begin the capture and storage process, the user may select a start control that appears on the user interface 102. Referring to FIG. 2, when initiated, the process then starts to monitor the image for change 36. When a change is detected that exceeds a predetermined threshold, the process waits for the image to stabilize. When the image has stabilized, the process captures the image 37. These steps of waiting for a change, further waiting for the image to stabilize, and capturing the image may be repeated until the user wishes to stop the process. When the user wishes to stop the capture and storage algorithm, he or she may then instruct the software to stop the execution of the algorithm 38 (or it stops automatically when the system is turned off) and complete the storage process in such a manner as to make the collection of stored images ready for retrieval and later use. At any time during the process of capturing and storing images, a user interface 40 may be displayed which allows adjustments to be made to parameters used by the image capture process.

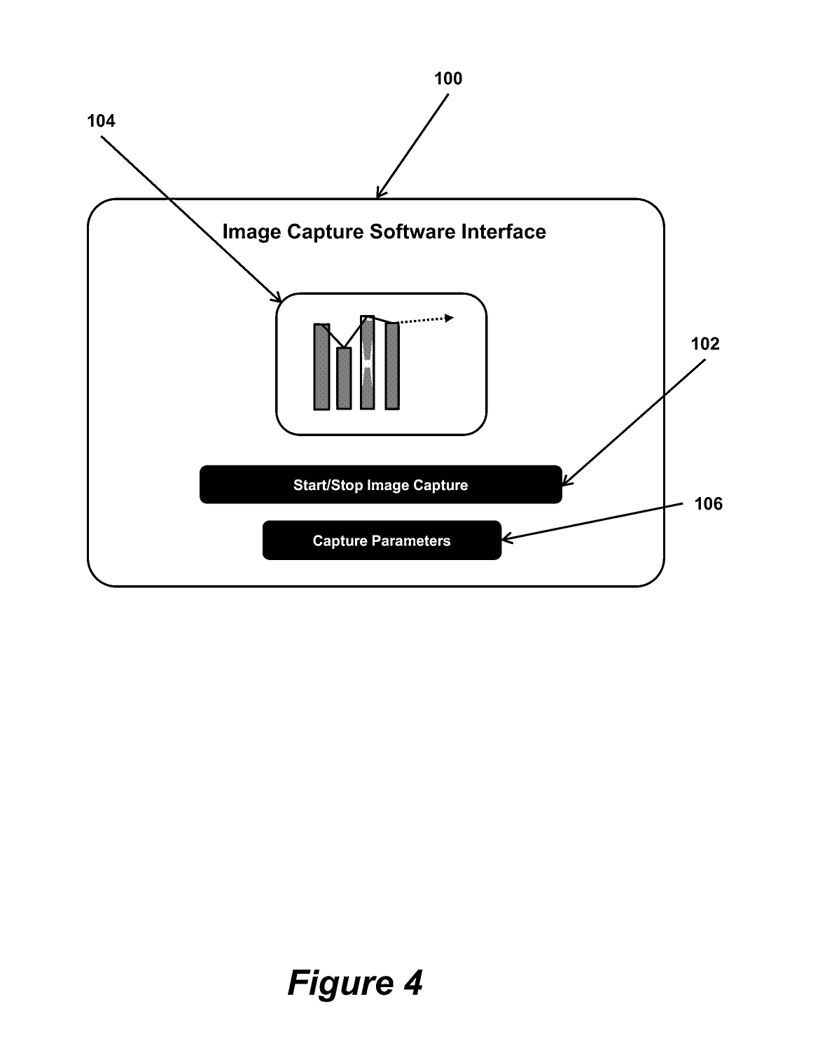

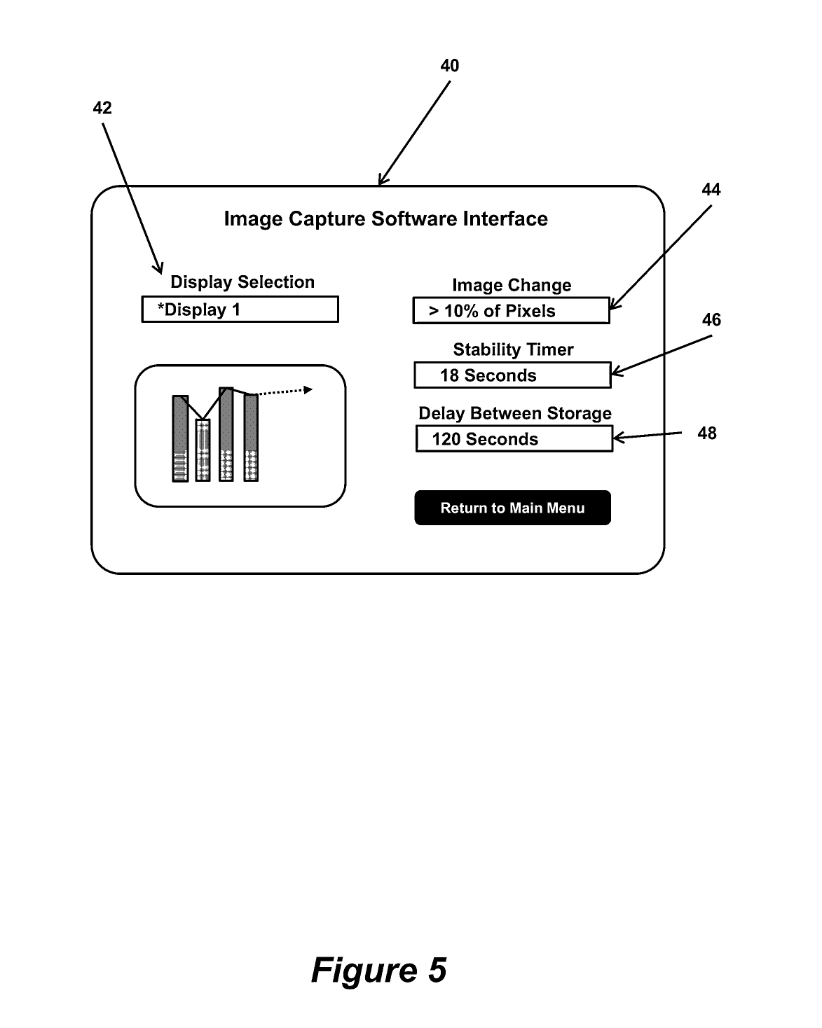

Referring to FIG. 4, which represents an initial or main user interface, a possible illustration of which is shown at 100, may present the user with a “Start/Stop Recording” button 102 that allows the capture and storage process to be immediately started. A display 104 of captured images may also be displayed on such a user interface to allow the user to monitor the images captured. It should be noted that a personal computer or other electronic device upon which the invention is implemented may have a graphics control device that is capable of being connected simultaneously to more than one graphics display. In such a circumstance, the user may be presented with the option of selecting which display device from which the image capture algorithm acquires images to be captured. The user may also have the option to select a location in which to store the collection of images captured by the image capture algorithm. Should the user wish to make adjustments to parameters used by the algorithm during the image capture process, the user may activate a selection 106 which then presents a parameters screen in the user interface. FIG. 5 illustrates an exemplary image of such a user interface. Using such an interface, the user may adjust parameters such as may be used by the image capture algorithm to select variables which may comprise the initial changes required in an image to trigger the capture process 44, the amount of time that such an image remains relatively unchanged after an initial change before that image is stored 46, and the time to elapse before the next image capture 48. When the user has made his or her selections, the software may return to the primary user interface 100.

The three variables just discussed may be used in controlling the level of change detail captured by the algorithm and as a result, the number of images captured and stored. In a preferred embodiment of the invention, the user of the image capture algorithm may be able to adjust each variable separately to arrive at an optimal balance between the level of detail captured and the cumulative total size of the images captured and stored. The first variable, the amount of initial change to an image refers to the change that occurs to an image before the algorithm captures the image. This insures that the algorithm does not capture a series of images that are identical or nearly so. The user may determine how much change is desired between captures depending upon the type of material being captured and set this variable accordingly. The second variable, the amount of time that the image remains relatively unchanged after the initial change before the image is stored, serves to insure that the image is not in a state of change when it is stored. The purpose of this variable is to, as much as is desirable, prevent partially formed images from being captured and stored. The user may also determine, based upon the type of images being captured, how long an image is to remain unchanged before it is stored. The third variable is the amount of time that must elapse between an image storage and the start of the next storage process. This variable is used to control the maximum number of images stored for a given time period and has the effect of providing the maximum storage capacity occupied by the series of captured and stored images.

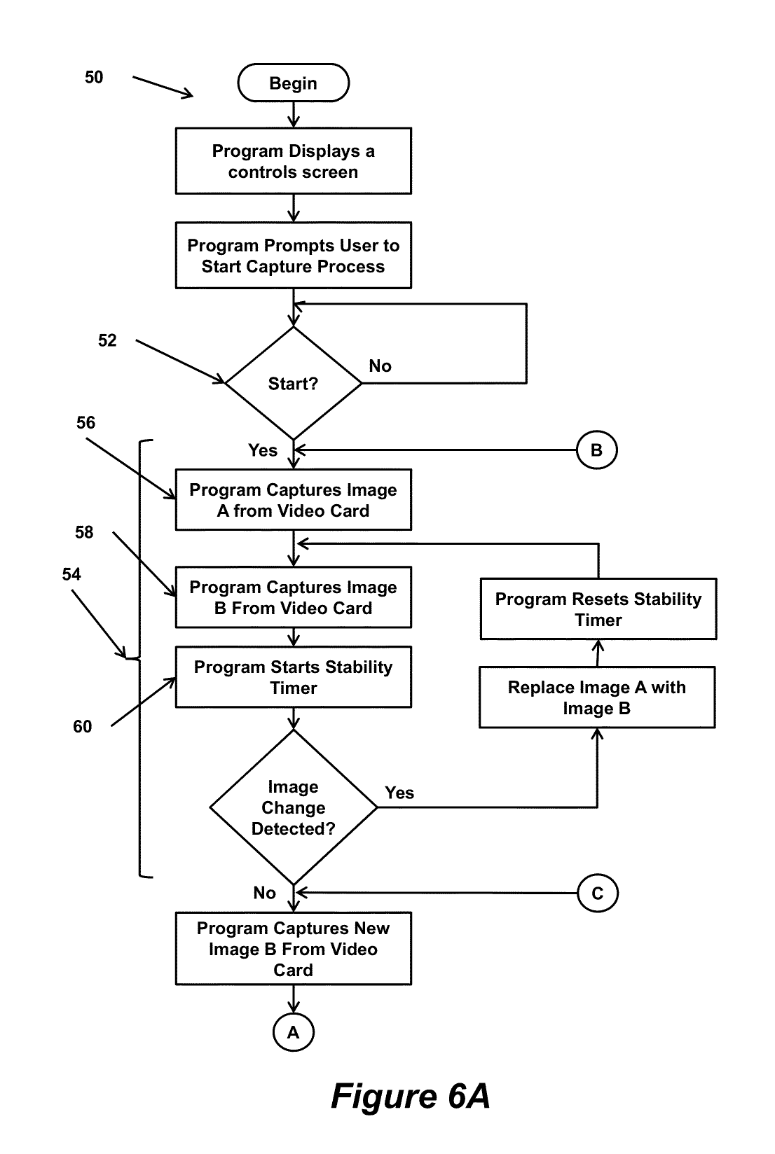

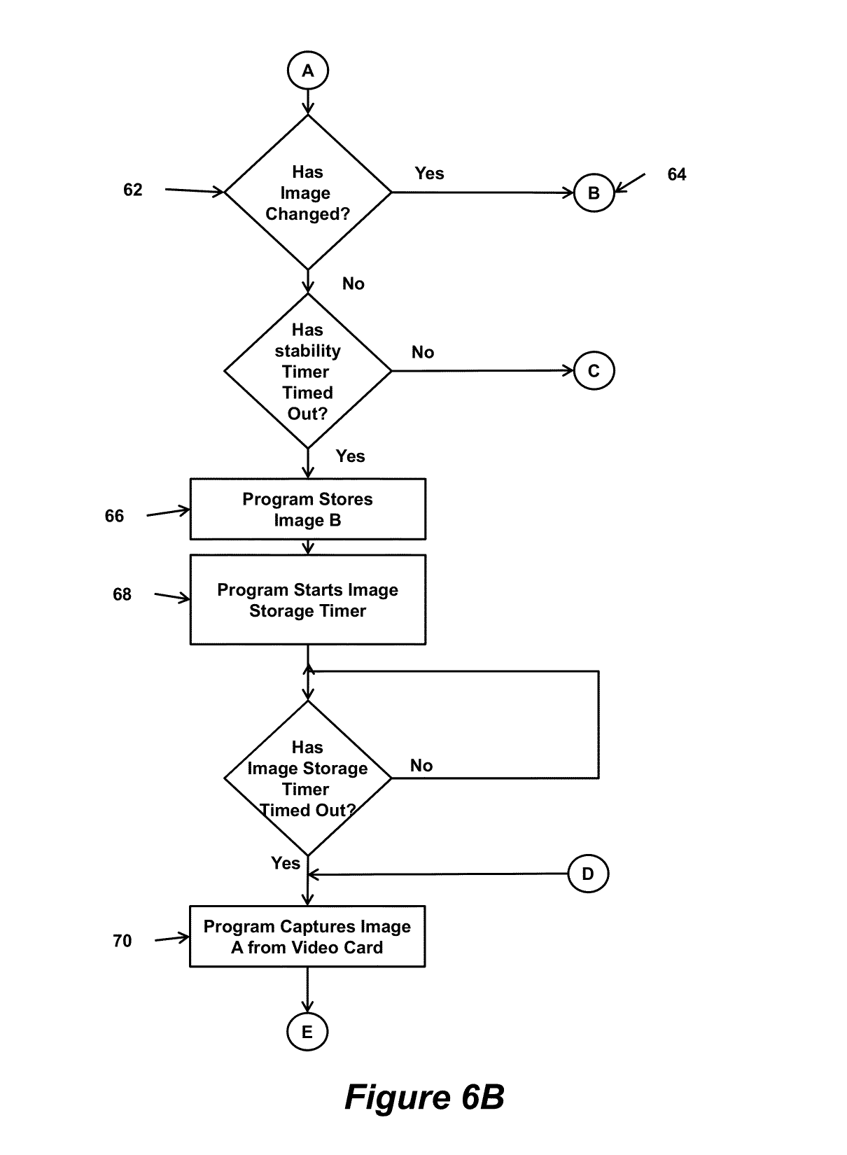

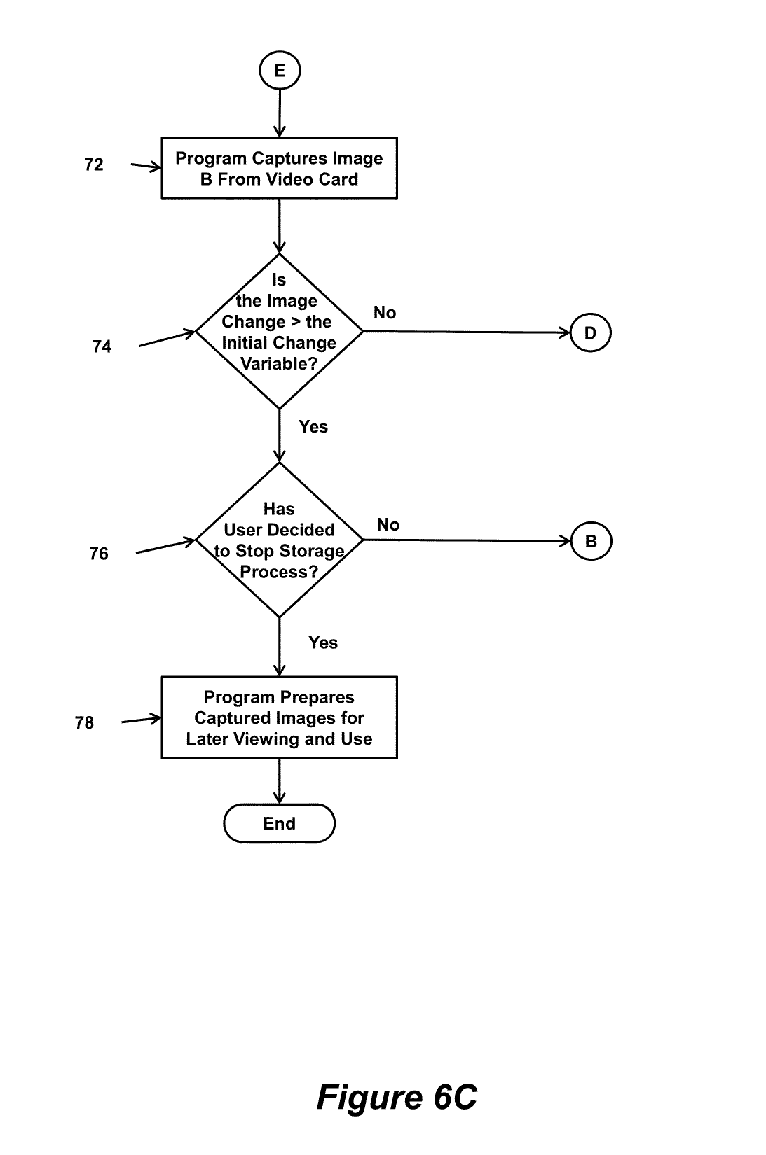

Referring to the flow diagram of FIGS. 6A-6C which illustrates another embodiment of the invention 50, when the user is satisfied with his parameter value selections, the user may then initiate the automated image capture process 52. This may be done by the selection of a control on the user interface 102 but may also be done with a keystroke or other such manner as the user finds convenient.

In order to optimize the number of images captured and stored, the invention waits for images to become stable before it captures and stores an image 54. Because software implementing the image capture algorithm monitors changes to the image over time as part of its analysis process, this exemplary software implementation uses two images which will be referred to as Image A and Image B. When the user initiates the image capture process, the computer software captures an image from the graphics control circuitry and stores this image as Image A 56. The software may then capture a second image from the graphics control circuitry and store that image as Image B 58. The software then starts a timer used to determine if the image is stable (Stability Timer) 60.

When the computer software has acquired Image A and Image B, the program compares Image B with Image A 62. The program determines if there has been a change between the two images that exceeds a predetermined amount. If such a change is detected, the algorithm may determine that the image is not stable and wait for it to stabilize before it is stored 64. If such a determination is made, the algorithm replaces Image A with Image B, resets the Stability Timer, and captures a new Image B. The algorithm then starts the Stability Timer. This process is repeated until there is not a change that exceeds the aforementioned predetermined amount from Image A to Image B.

When there is no substantial change detected, in other words, the algorithm determines that the image remains stable from one comparison to the next, the algorithm continues to monitor the images for change until the Stability Timer reaches an amount of time that the user has selected (times-out), meaning that the image is stable enough for capture and storage. If the image changes before the Stability Timer times-out, the process starts anew 64. If the image is stable enough for storage, the algorithm stores Image B in the file location chosen by the user 66.

After an image is stored, the algorithm starts a second timer used to determine the amount of time between image storage (Image Storage Timer) 68. When this Image Storage Timer expires, the software captures a new Image A 70 and then a new Image B 72 and compares the two images to determine if there has been a change that exceeds the predetermined amount of initial change variable discussed above 74. If there has not been a change that exceeds this amount, a new Image B is captured and compared against Image A. This process continues until a change is detected that exceeds the amount specified by the initial change variable. When this occurs, the process of waiting for the image to stabilize begins 54.

This entire process; initial change detection, image stability monitoring, image storage, and time delay between storages, repeats until the user wishes to stop the image capture process 76. When the user wishes to stop the capture process, the software stops running the image capture algorithm and prepares the captured images 78 so that they may later be viewed and manipulated by the user as he or she sees fit.

In another embodiment of the invention, the user may run the image capture software as described above but the software has the additional capability of recording audio or audio/video files using hardware that may be connected to or otherwise available to the processor of the computer or electronic device. The capture software in this embodiment may encode information that identifies the capture times of each captured image such that the images can later be viewed in a manner that is synchronized with the audio or audio/video files recorded. An example of how this embodiment may be used would be to generate a presentation that not only includes a series of screen images but also an audio or audio/video recording of what is said or demonstrated along with each image.

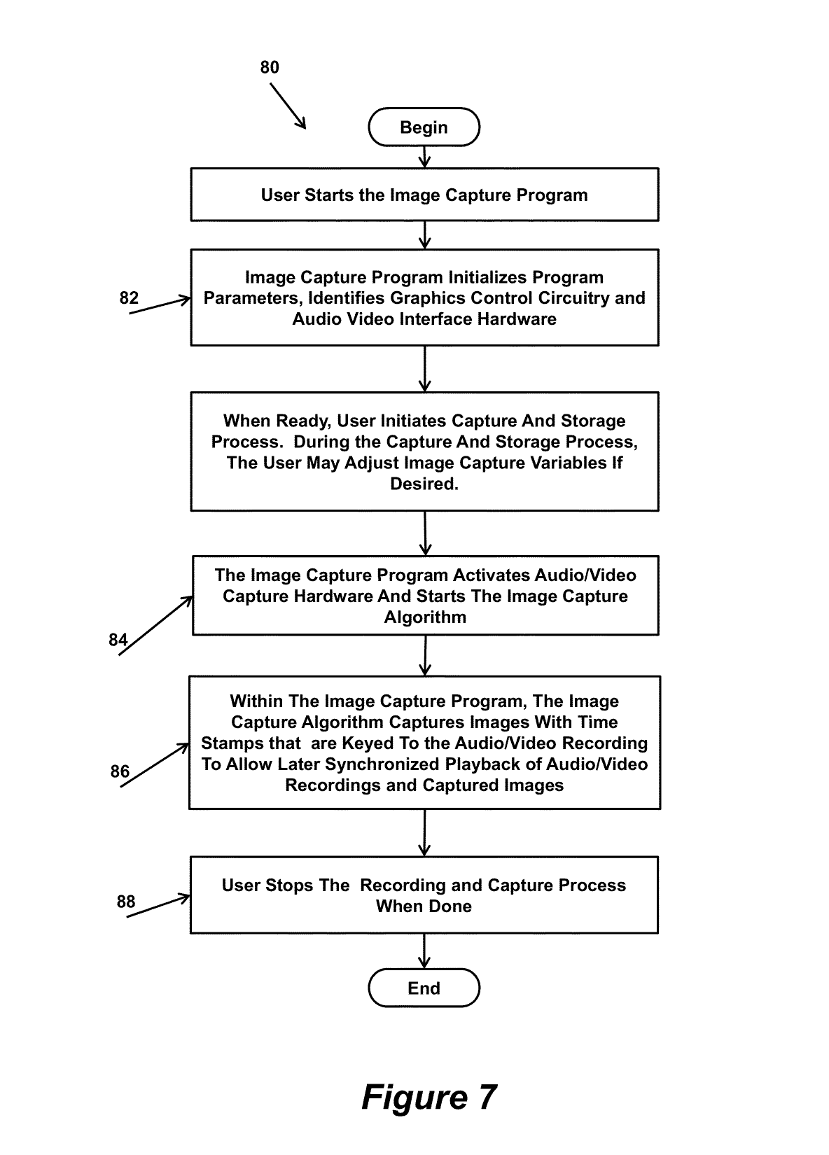

Referring to FIG. 7, a series of exemplary steps to accomplish this embodiment is shown in 80. The image capture software is started by the user. The software then initializes software parameters, including those variables used by the capture algorithm, and identifies the video graphics card or cards available for image capture 82. To enable the audio or audio/video capabilities, the software then identifies connected audio or audio/video capture circuitry depending upon which type of recording is to be captured. The image capture software displays a user interface and prompts the user to make any desired adjustments to the image capture variables and prepares the connected capture circuitry for recording.

When the user is ready to start the audio or audio/video recording and image capture process, the user may instruct the image capture software to start the capture process. When this instruction is given, the image capture software activates the audio or audio/video capture hardware and starts the image capture algorithm 84.

The image capture algorithm then runs in the same manner as previously detailed but with the additional step of adding time stamps to each captured image 86. These time stamps are keyed to the audio or audio/video file that is being recorded. These time stamps allow additional software to display the captured images in a manner that is synchronized to the playback of the audio or audio/video recording as may be the case.

When the user has completed the image capture and audio or audio/video recording, the user may instruct the image capture software to stop the image capture process 88. At this time, the software will also instruct the audio or audio/video recording hardware to stop recording and prepare the associated files for later use as desired.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A system for capturing and storing images from a computing device comprising:
a computing device comprising a processor, a storage system, and graphics control circuitry;
at least one computer display monitor that is associated with and in electronic communication with said computing device for display of information contained in the graphics control circuitry; and
an image capture device in electronic communication with said computing device which monitors a stream of images communicated from the computing device to a computer display monitor in electronic communication with the computer device and stores one or more individual images upon the satisfaction of predetermined capture conditions before each storage.

2. The system of claim 1, wherein:
said capture conditions comprise a change to the monitored images which exceeds a predetermined amount.

3. The system of claim 2, wherein:
said capture conditions further comprise, after said initial change, the monitored images remaining predominantly unchanged for a period of time.

4. The system of claim 2, wherein:
said capture conditions further comprise a predetermined period of time that elapses between each image storage.

5. The system of claim 1, further comprising:
an audio recording device connected to and in electronic communication with said computing device where an audio recording may be captured simultaneously with said storage of one or more images.

6. The system of claim 5, wherein:
said audio recording device further comprising the capability of recording a stream of video images is connected to and in electronic communication with said computing device where a video recording is captured simultaneously with said storage of one or more images.

7. A method of automatically capturing and storing images, comprising the steps of:
monitoring a stream of images present in the graphics control circuitry of the system of claim 1; and
capturing and storing an image from said stream of images when a predetermined amount of change is detected in the image being monitored.

8. The method of claim 7, wherein:
said image is captured from the portion of said graphics control circuitry associated with a computer display monitor connected to the computing device where said computer display monitor is selectable from among computer display monitors connected to said graphics control circuitry.

9. The method of claim 7, wherein:
said amount of change required before said image is captured is variable.

10. The method of claim 7, further comprising the step of:
waiting for an image to remain predominantly unchanged for a period of time before said image is captured and stored.

11. The method of claim 10, wherein:
said amount of time that an image remains predominantly unchanged prior to capture is variable.

12. The method of claim 7, further comprising the step of:
waiting for a predetermined period of time to elapse after capturing and storing of an image before the start of the capture and storage process for an additional image.

13. The method of claim 12, wherein:
said amount of time elapsing before the start of the next capture and storage steps is variable.

14. The method of claim 7, further comprising the step of:
displaying a user interface on a computer display monitor associated with and in electronic communication with said system, which includes a representation of the last image captured and stored.

15. The method of claim 14, further comprising the step of:
displaying, in said user interface, variables which are adjustable to vary the parameters of said image capture method.

16. A method comprising the steps of:
capturing and storing images from the graphics control circuitry of the system of claim 1 when the following conditions are present:
an image has changed by a user selectable amount;
a user selectable period of time has passed since the last image was captured; and
the image is not currently undergoing a substantial change.

17. A method of comprising the steps of:
capturing and storing images from the graphics control circuitry of the system of claim 5;
simultaneously capturing audio recordings from the audio recording device of claim 5; and
storing the images and audio recordings in a manner that permits the stored images to be displayed in synchronization with a replay of the audio recordings.

18. The method of claim 17, further comprising the steps of:
simultaneously capturing video recordings from the recording device of claim 6; and
storing said images and video recordings to be stored in a storage device in such a manner that they may be replayed such that said stored images are displayed in synchronization with replay of the video recordings.
